(19) United States
(12) Patent Application Publication
(10) Pub. No.: US 2011/0174129 A1
(43) Pub. Date: Jul. 21, 2011

(54) MITER SAW HAVING AN INSERT WHICH PREFERABLY BORDERS A SAWING SLOT

(76) Inventor: Gerhard Weusthf, Schapen (DE)

(21) Appl. No.: 13/063,827

(22) PCT Filed: Sep. 10, 2009
(86) PCT No.: PCT/EP2009/006585

§ 371 Date: Mar. 14, 2011

(30) Foreign Application Priority Data
Sep. 12, 2008 (DE) 10 2008 047 064.3
Sep. 12, 2008 (DE) 10 2008 047 065.1
Sep. 12, 2008 (DE) 20 2008 012 213.9

(51) Int. Cl. B23D 45/04; B23D 45/14; B23D 47/02

(52) U.S. Cl. 83/471.3

(57) ABSTRACT

A miter saw has a supporting table, a rotation device which can rotate about a vertical axis relative to the supporting table, a miter arm which particularly can rotate about the vertical axis, and a saw device arranged on the miter arm. The saw device is arranged above the supporting table to be movable up-and-down and/or to be pivotable. The rotation device has a rotation base with a recess and an insert arranged in the recess, wherein the insert preferably at least partially borders a sawing slot. The miter saw has a high cutting quality and a safe support of the workpiece is produced in that the insert and/or the recess are constructed in such a manner that the insert can be adjusted in its height and/or the vertical alignment of the insert can be adjusted relative to the supporting table and/or relative to the rotation base.

The invention relates to a crosscut and miter saw having a seating table, having a rotary means that is rotatable about a vertical axis relative to the seating table, having a miter arm that is rotatable, in particular, about the vertical axis, having a sawing device disposed on the miter arm, the sawing device being disposed above the seating table such that it can be moved up and down, preferably in a pivoting manner, the rotary means having a rotary means base that has a receiver and an inset disposed in the receiver, the inset preferably delimiting a saw slot, at least partially.

A crosscut and miter saw can be used to trim workpieces, in particular workpiece bars, to size at an angle—the miter angle—that is other than the right angle.

The workpiece in this case is placed onto a seating table of the crosscut and miter saw. A sawing device, having a rotatably disposed saw blade for sawing the workpiece, is disposed on the miter arm, above the seating table. The miter arm is preferably mounted on a rotary means in a functionally operative manner so as to be rotatable about a vertical axis. The miter angle can be set through rotation of the miter arm by means of the rotary means. Further, the miter arm is preferably pivotable about a miter axis, the miter axis extending substantially perpendicularly in relation to the vertical axis, namely, in a workpiece plane, or cutting plane. For this purpose, a preferably lockable pivot joint can be provided between the miter arm and the rotary means.

After the miter angle has been set, the workpiece can be docked, or sawn through, by means of the sawing device, for which purpose the sawing device can be lowered. Sawing off can be effected, in particular, through pivoting of the sawing device about a transverse axis. The transverse axis in this case is substantially perpendicular to the miter axis. The sawing device is designed so as to be displaceable, preferably, in the radial direction relative to the vertical axis—preferably parallelwise in relation to the miter axis, by means of a sliding guide device, such that, after the sawing device has been lowered to the level of the workpiece, the workpiece can be cut through by radial displacement of the sawing device.

A docking saw having a rotary means that serves as a workpiece seating surface is known from DE 20 2005 015 528 U1. The docking saw in this case has a seating table, the rotary means being rotatably mounted in a receiver of the seating table. Here, the rotary means is realized as a rotatably mounted saw table. Disposed above the saw table is a sawing device having a drive motor and a saw blade. The rotatable saw table has a saw slot, the saw blade, when in a sawing position, being able to go into the saw slot. The saw table has a receiver, in which there is disposed an inset in the form of a saw slot insert. The saw slot is delimited by the saw slot insert detachably inserted in the receiver. Realized on the saw slot insert, in the saw slot, is an arcuate portion, which matches the diameter of the saw blade, such that, during sawing, dust and chips are carried out of the saw slot, along the arcuate portion. Here, the inset in the form of the saw slot insert is fastened in the receiver in a non-positive manner. This is achieved through clamping in the region of the underside of the saw slot insert.

The crosscut and miter saw known in the prior art is not yet optimally realized. Practice has shown that, when the saw table, or the rotary means, is turned, the workpiece lying thereon can also slip to some extent, such that the cut quality in the case of known crosscut and miter saw is problematic, since, owing to the concomitantly rotating, relatively large surface of the saw table, there is no secure workpiece seating. As a result, the crosscut and miter saws known in the prior art are therefore not yet optimally realized.

The invention is therefore based on the object of designing and developing the crosscut and miter saw mentioned at the outset, in such a way that its cut quality is improved and insecure seating of the workpiece is prevented.

The previously indicated object is now achieved for a crosscut and miter saw in that the inset and/or the receiver is or are realized in such a way that the inset—relative to the seating table and/or relative to the rotary means base—can be disposed in a height adjustable manner and/or the alignment of the inset can be set in respect of height. This has the advantage that the inset—in particular, in respect of the height of the seating table—can be set, as a result of which the top side of the inset can preferably be aligned flush with the rotationally fixed seating table. In this way, the inset and the seating table can be made level with one another. A secure workpiece seating can thereby be set for the workpiece, the rotationally fixed seating table being able to constitute a part of the workpiece seating and the inset being able to constitute the other part of the workpiece seating. The height of the inset can therefore be set, preferably steplessly, to the height of the seating table, the rotationally fixed seating table preferably extending on both sides of the vertical axis, in particular to close to the vertical axis. This can be realized, in particular, in that the rotary means extends partially below the seating table. In particular, the rotary means base can extend partially below the receiving table, for example in the form of a rotary disk. Owing to the fact that the seating table partially covers the rotary means base, it is possible to achieve a very compactly realized crosscut and miter saw, which requires only a small amount of space and, in particular, is easily transportable. A bracket can project over the rotary means base/over the rotary disk. The inset can project over the rotary means base, in particular out of the receiver. At least one adjusting means that can be operated manually is preferably provided for aligning the inset in respect of height, preferably steplessly in respect of height. The adjusting means preferably connects the inset to the rotary means base in the receiver. A simple design of the adjusting means can be achieved through one or more adjusting screws that operatively connect the inset and the rotary means base to one another. The disadvantages described at the outset are therefore avoided, and corresponding advantages are achieved.

There are a multiplicity of possibilities for designing and developing the crosscut and miter saw according to the invention in an advantageous manner. For this, reference may first be made to the claims that follow claim 1. A preferred design of the invention is now explained more fully in the following on the basis of the drawing and the associated description. In the drawing:

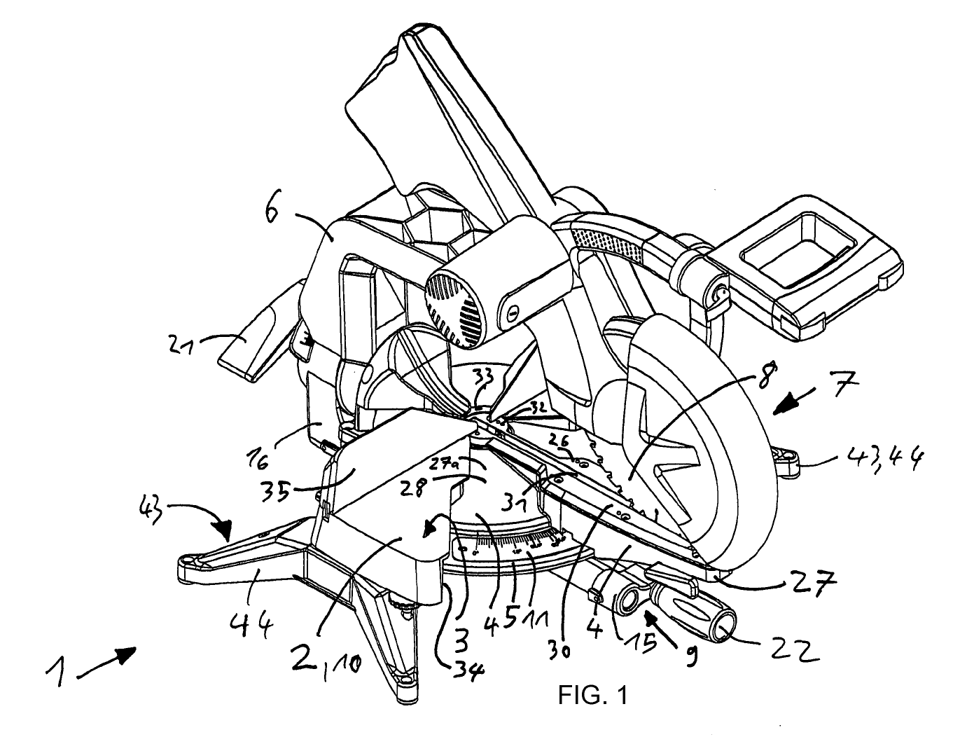

FIG. 1 shows a schematic, perspective representation of a crosscut and miter saw, viewed obliquely from above at the front left,

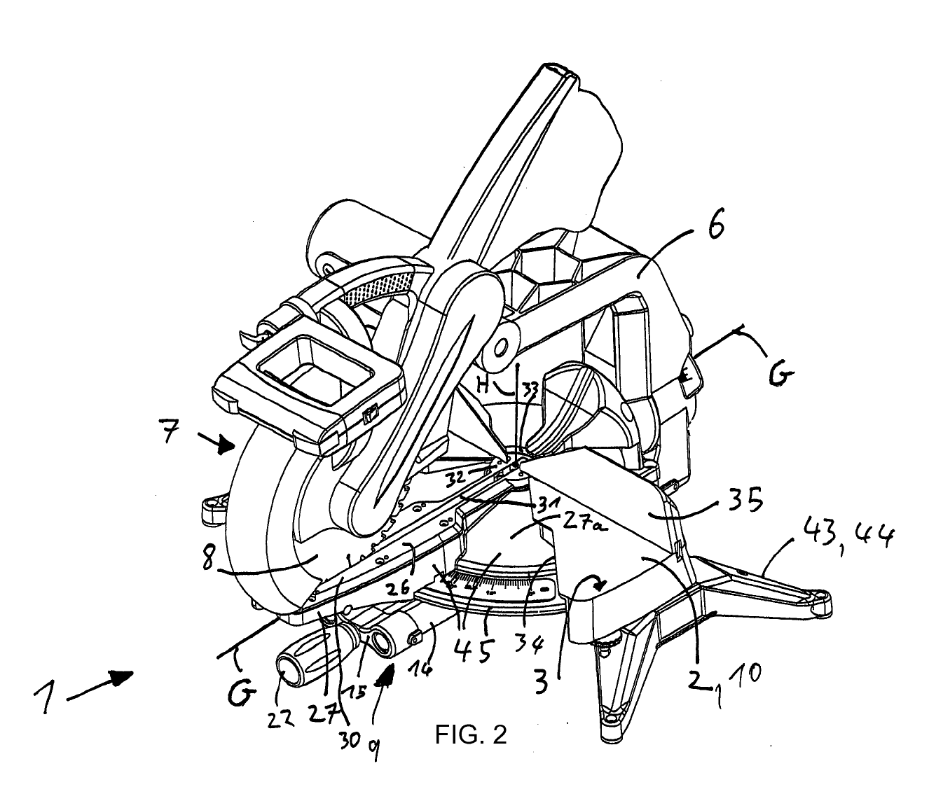

FIG. 2 shows a schematic, perspective representation of a crosscut and miter saw from FIG. 1, viewed obliquely from above at the front right,

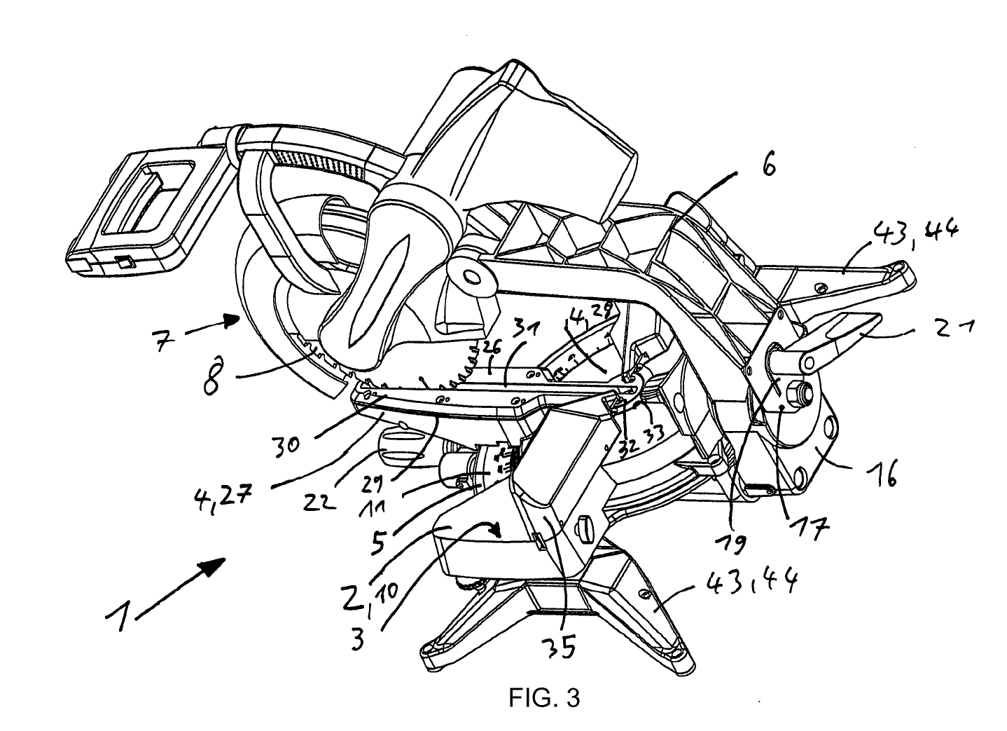

FIG. 3 shows a schematic, perspective representation of a crosscut and miter saw from FIGS. 1 and 2, viewed obliquely from above at the back,

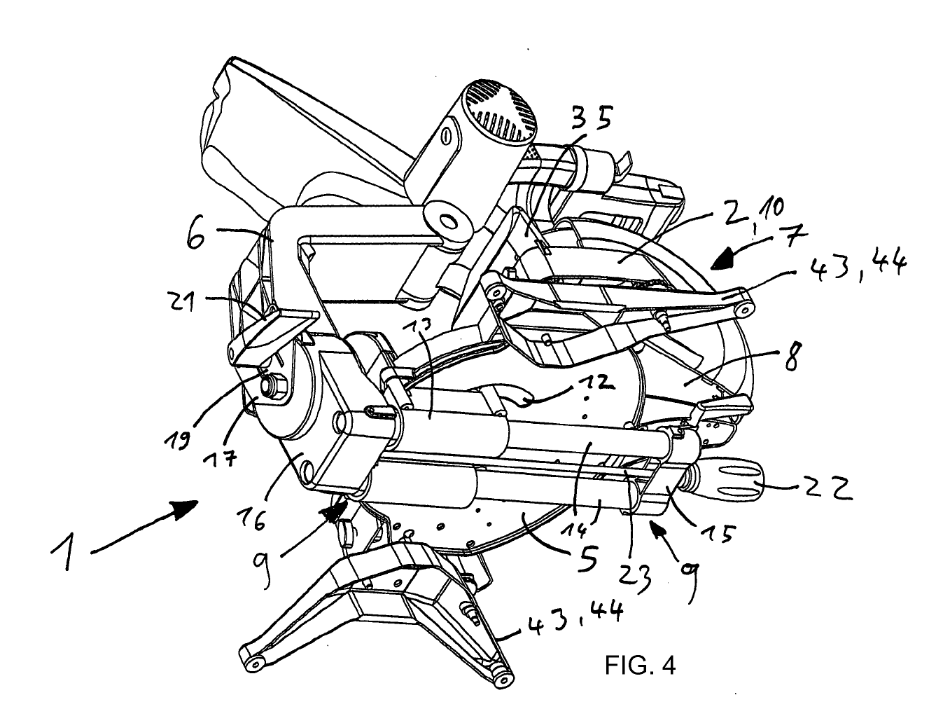

FIG. 4 shows a schematic, perspective representation of the crosscut and miter saw from FIGS. 1 to 3, viewed obliquely from below at the back,

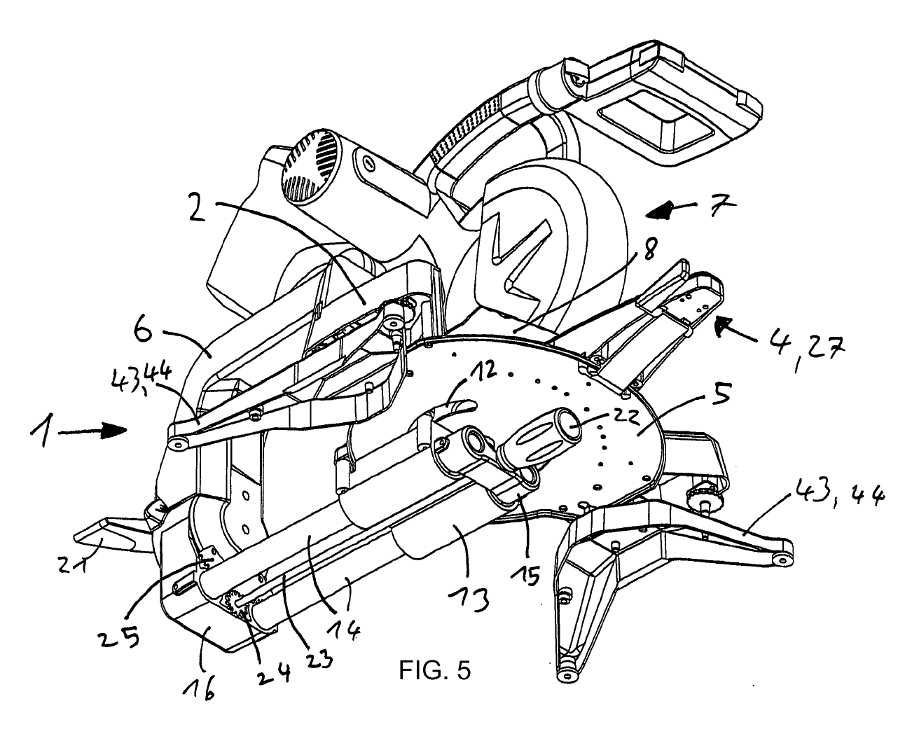

FIG. 5 shows a schematic, perspective representation of the crosscut and miter saw from FIGS. 1 to 4, viewed from below at the front,

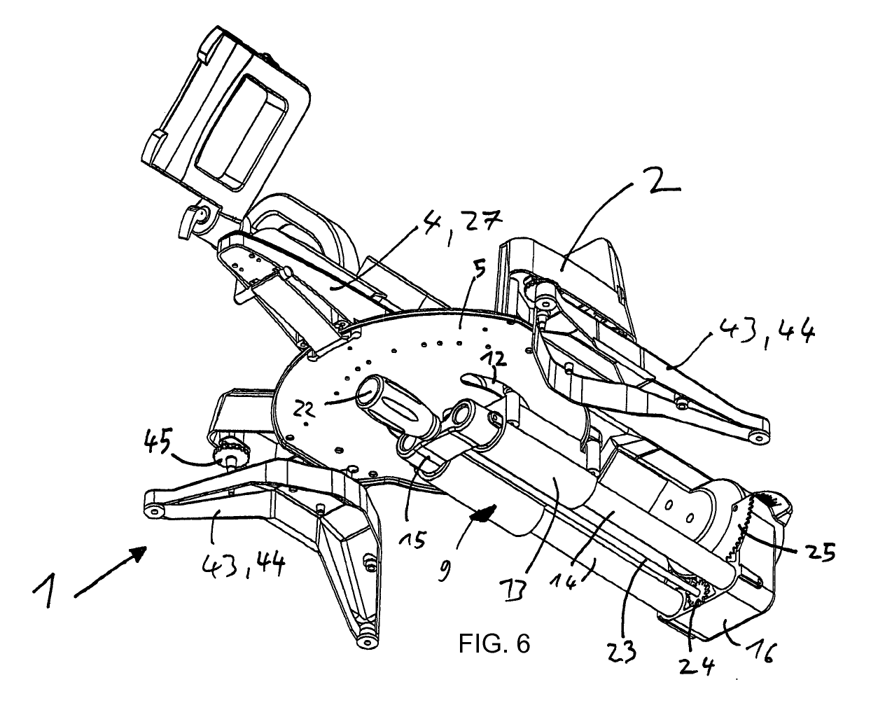

FIG. 6 shows a further schematic, perspective representation of the crosscut and miter saw from FIGS. 1 to 5, likewise viewed from below at the front,

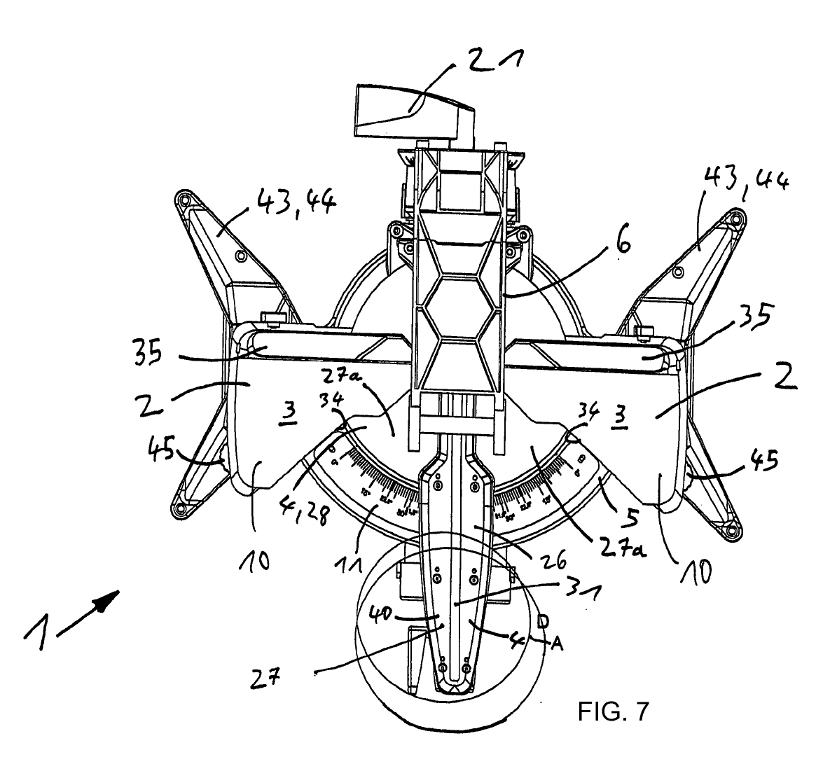

FIG. 7 shows a schematic top view of the crosscut and miter saw from FIGS. 1 to 6,

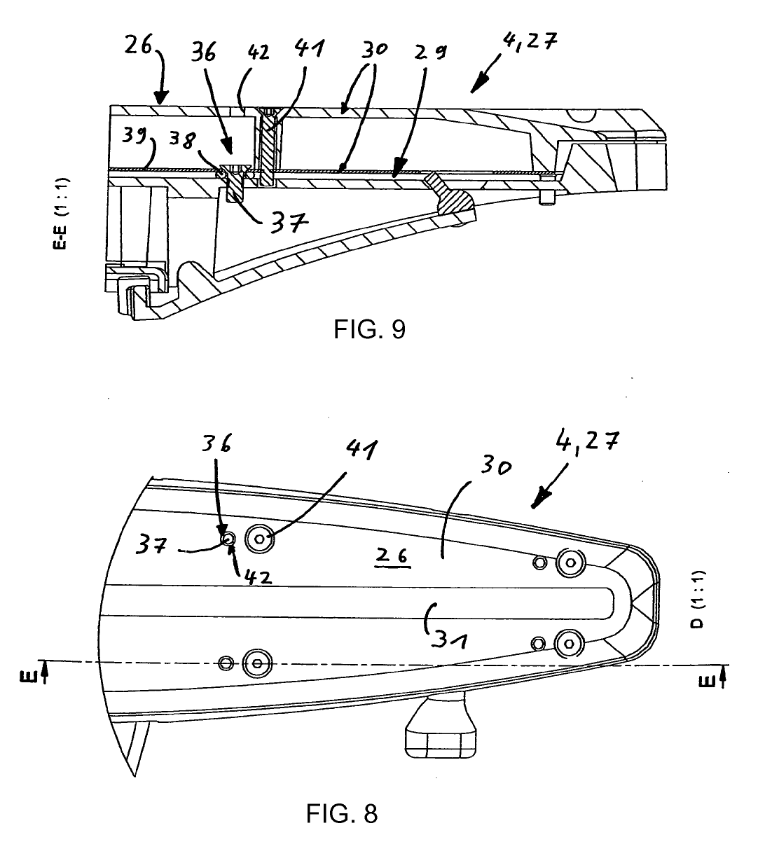

FIG. 8 shows a detail view of the portion D from FIG. 7 with the bracket of the crosscut and miter saw from FIGS. 1 to 7,

FIG. 9 shows a schematic vertical section, along the line E from FIG. 8, of the bracket of the crosscut and miter saw, and

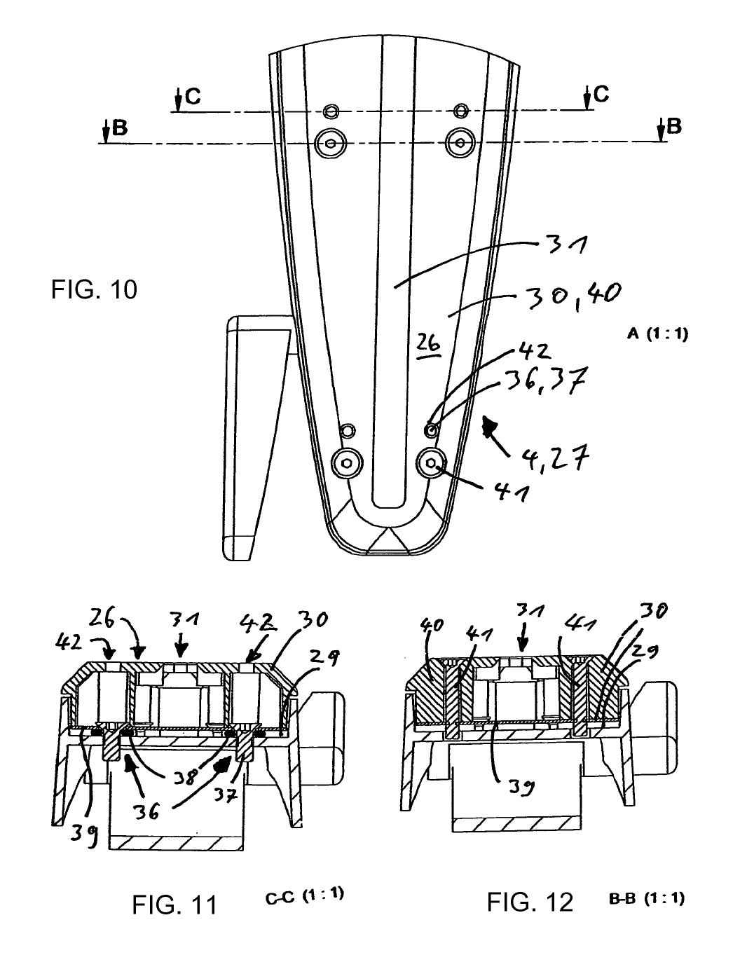

FIG. 10 shows, in a manner similar to FIG. 8, a detail view of the portion A from FIG. 7 with the bracket of the crosscut and miter saw

FIG. 11 shows a schematic vertical section, along the line C from FIG. 10, of the bracket of the crosscut and miter saw,

FIG. 12 shows a schematic vertical section, along the line B from FIG. 10, of the bracket of the crosscut and miter saw, and

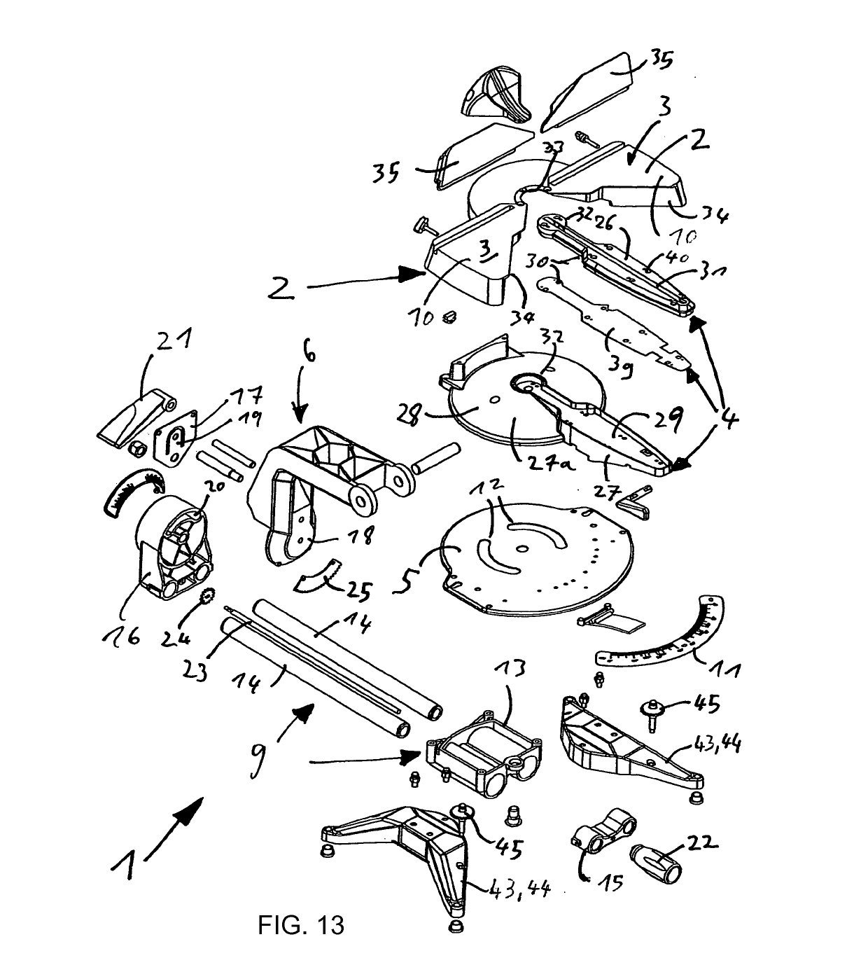

FIG. 13 shows a schematic, exploded representation of the principal components of the crosscut and miter saw.

Depicted clearly here, in FIGS. 1 to 13, are a crosscut and miter saw 1 and its principal components.

The crosscut and miter saw 1 can be used to cut, in particular, strips, panels or plates to the desired length, preferably including the desired miter cuts. The crosscut and miter saw 1 can be used not only to make cuts at right angles to the longitudinal axis of the workpiece, not represented, but also so-called miter cuts at an acute angle to the longitudinal axis of the workpiece.

The crosscut and miter saw has a seating table 2. The workpieces can be disposed, in particular transversely, on the seating table 2, i.e. the workpieces extend with their longitudinal axis transversely on the seating table 2. The seating table 2 has a top side 3, the top side 3 serving to seat the workpiece, not represented.

The crosscut and miter saw 1, further, has a rotary means 4 that can be pivoted about a vertical axis H relative to the seating table 2. The vertical axis H is indicated in FIG. 2. The constituent parts of the rotary means 4 to be described in detail in the following are shown clearly by, in particular, FIG. 13. Here, the rotary means 4 is disposed on a base plate 5. The base plate 5 serves as a support element (not designated in greater detail) for the rotary means 4. The rotary means 4 is supported on the base plate 5 so as to be pivotable about the vertical axis H (cf. FIG. 2).

A miter arm 6 is connected to the rotary means 4 in a functionally operative manner. The miter arm 6 can be pivoted, together with the rotary means 4, about the vertical axis H. A sawing device 7 is disposed on the miter arm 6. The sawing device 7 is disposed above the seating table 2. The sawing device 7 can be moved up and down, such that a workpiece disposed on the seating table 2 can be cut, or docked, by means of the sawing device 7. The sawing device 7 has a saw blade 8, in particular a circular saw blade, which can preferably be motor-driven. The sawing device 7 is mounted, at one end of the miter arm 6, so as to be pivotable upwards and/or downwards on a transverse axis, not designated in greater detail. The miter arm 6 and the sawing device 7 can be pivoted, relative to the rotary means 4 and to the seating table 2, about a miter axis G (cf. FIG. 2). The miter axis G extends substantially in the radial direction in relation to the vertical axis H. The miter axis G is perpendicular to the vertical axis H.

The sawing device 7 is disposed so as to be displaceable along the miter axis G by means of a sliding guide device 9. The crosscut and miter saw 1 is therefore realized as a pull-through saw. Because of the sliding guide device 9, the length of the saw cut is not limited to the diameter of the saw blade 8, but is extended by the possible displacement path of the sawing device 7, by means of the sliding guide device 9. The length of the saw cut therefore results from the length of pass and from the diameter of the saw blade 8. Since the sawing device 7 is pivotable both about the vertical axis H and about the miter axis G, so-called “double miter cuts” can also be performed by means of the crosscut and miter saw 1.

Here, the sliding guide device 9 is disposed substantially below the base plate 5. The rotary means 4 here is disposed partially in the region between the seating table 2 and the base plate 5. Owing to the fact that the rotary means 4, the base plate 5 and the sliding guide device 9 are realized as separate assemblies, which are disposed sequentially over one another in a type of “sandwich construction method”, the fixed seating table 2 can extend substantially in the lateral direction as far as the vertical axis H and additionally still cover the rotary means 4, at least partially. As a result, the rotationally fixed workpiece seating surface, or the top side 3 of the seating table 2, is enlarged. Upon setting of the pivot position about the vertical axis H, the workpiece therefore has a large-area contact with the rotationally fixed seating table 2, enabling the workpiece to be securely seated, in particular upon setting of the pivot position about the vertical axis H. The sliding guide device 9 is represented in a maximally extended position in FIGS. 5 and 6.

The seating table 2 has two projections 10. The base plate 5 and the seating table 2 are screw-connected to one another at the projections 10. The seating table 2, which is constituted substantially by the two projections 10, and the base plate 5 constitute a solid assembly. The base plate 5 is preferably realized in the form of a disk. An angle scale 11 is disposed on the base plate 5. The angle scale 11 in this case extends arcuately between the two projections 10. The rotary means 4 is disposed partially between the projections 10.

Here, the base plate 5 has at least one arcuate guide slot 12. As shown clearly by FIG. 13, two guide slots 12 are provided here. The guide slots 12 are opposite one another with respect to the vertical axis H, and are disposed concentrically in relation to the vertical axis H. Here, the sliding guide device 9 and the rotary means 4 are connected to one another by at least one fastening element, preferably a bolt or a screw (not represented in detail here), extending through the guide slots 12. In particular, two or more bolts can extend through the guide slot 12 and connect the rotary means 4 and the sliding guide device 9 to one another. In the region of the vertical axis H, a screw/bolt (not represented in greater detail) projects through the base plate 5, for the purpose of mounting the rotary means 4 so as to be pivotable about the vertical axis H on the base plate 5. The rotary means 4 has a corresponding receiver (not represented) in the region of the vertical axis H, the screw/bolt engaging in the receiver.

The sliding guide device 9 has a sliding guide 13, preferably realized in the manner of a block. The sliding guide device 9 has at least one guide rod 14. Here, two guide rods 14 are provided. The sliding guide 13 is connected to the rotary means 4, as described above. The sliding guide 13 guides the two guide rods 14, which are aligned parallelwise in relation to one another, the guide rods 14 extending parallelwise in relation to the miter axis G. The guide rods 14 are disposed so as to be displaceable relative to the sliding guide 13. The sliding guide 13 has two guide-rod receivers (not designated in greater detail) that match the cross-section of the guide rods 14. The two guide rods 14 are connected to one another at one end by a rod clamping piece 15. Disposed at the other end of the guide rods 14 is a miter-arm mount 16, which receives the two guide rods 14 in corresponding receivers (not designated in greater detail). Between the rod clamping piece 15 and the miter-arm mount 16, the sliding guide 13 encompasses the two guide rods 14.

The rotary means 4 is connected to the miter arm 6 via the sliding guide device 9 and via the miter arm mount 16. The miter arm 6 is preferably realized substantially in an L shape. An electric motor, for driving the saw blade 8, is preferably disposed on the miter arm 6, or on the sawing device 7.

The miter arm 6 is mounted on the miter-arm mount 16 so as to be pivotable about the miter axis G. On the miter arm 6, a miter plate 17 is disposed on one side and a counter-plate 18 is disposed on the other side. Here, the counter-plate 18 is realized on the miter arm 6. When in the mounted state, the miter-arm mount 16 is disposed between the miter plate 17 and the counter-plate 18. The miter-arm mount 16 is preferably connected to the miter plate 17 and to the counter-plate 18 by a bolt (not designated in greater detail), such that the miter arm 6 can be pivoted about the bolt. The bolt in this case extends along the miter axis G. For the purpose of fixing the miter arm 6 in a pivot position about the miter axis G, the miter plate 17 preferably has a flexible joint piece 19 (cf. FIG. 13). The flexible joint piece 19 has a bolt opening, not designated in greater detail. The miter-arm mount 16 has an arcuate, elongate hole 20, a miter setting bolt (not designated in greater detail) engaging through the elongate hole 20 and the bolt opening of the joint piece 19. The miter setting bolt is connected to a lever handle 21. Through actuation of the lever handle 21, the joint piece 19 can be drawn against the miter-arm mount 16, such that the joint piece 19 clamps the miter arm 6 in a defined pivot position about the miter axis G, relative to the miter-arm mount 16. A differently functioning fixing device can also be provided to enable a particular angle, i.e. a particular pivot position of the miter arm 6, to be set and fixed.

The pivot position of the miter arm 6 is effected here by means of a toothed wheel adjustment. Provided for this purpose is a rotary handle 22, which is connected to a shaft 23. The shaft 23 in this case extends between the two guide rods 14. A toothed wheel 24 is disposed on the shaft 23. The shaft 23 extends between the rod clamping piece 15 and the miter-arm mount 16, and is mounted on the latter. The toothed wheel 24 is disposed in the region of the miter-arm mount 16, or of the counter-late 18. A toothed disk arc 25 is fastened to the counter-plate 18, or, more generally, to the miter arm 6, the toothed disk arc 25 having an external toothing (not designated in greater detail), which is in engagement with the toothed wheel 24 on the shaft 23. The toothed disk arc 25 in this case is disposed concentrically in relation to the miter axis G. Through rotation of the rotary handle 22, the shaft 23 can be rotated with the toothed wheel 24, such that the toothed disk arc 25 in engagement with the toothed wheel 24 is moved and the miter arm 6 is thereby swiveled.

As shown clearly by, for example, FIGS. 1, 2 and 3, the seating table 2 at least partially covers the rotary means 4. The top side 26 of the rotary means 4 that extends only partially at the level of the seating table 2 in this case projects out over the rest of the top side (not designated in greater detail) of the rotary means 4. Here, the rotary means 4 has the form of a rotary disk 27a having a bracket 27 realized thereon. The rotary means 4 is constituted here by a rotary means base 28 in the form of the rotary disk 27a with the bracket 27. The rotary means base 28 has a receiver 29. The upwardly open receiver 29 extends substantially from the vertical axis H radially along the rotary disk 27a and over the bracket 27. An inset 30 is disposed in the receiver 29.

The inset 30 preferably has the form of a saw slot insert. The inset 30 is preferably shaped so as to match the receiver 29. A saw slot 31 extends along the bracket 27 and further into the rotary disk 27a, as far as the vertical axis H, the inset 30 delimiting the saw slot 31 at least partially—here, preferably, delimiting it fully.

The bracket 27 and, consequently, the saw slot 31 extend radially outwards, parallelwise in relation to the miter axis G, substantially from the center of the rotary disk 27a of the rotary means base 28. Here, the rotary means base 28 is rotatably mounted by the screw/bolt, not designated in greater detail, which extends through the base plate 5, such that the rotary means base 28 is coupled to the sliding guide 13 by means of the bolts extending through the guide slots 12. Realized on the rotary means base 28, preferably as a single piece, are the bracket 27 and the rotary disk 27a. The rotary disk 27a is realized so as to be thicker in the region of the rotary axis H than at its edge, as a result of which the bracket 27 projects further over the rotary disk 27a, towards the periphery of the rotary disk 27a.

Also extending in the region of the bracket 27 is the receiver 29 for the inset 30. The saw slot 31 extends in the rotary disk 27a as far as into the region of the vertical axis H. In the region of the vertical axis H, the rotary means 4, in particular the rotary means base 28 and the inset 30, has a bearing projection 32. The bearing projection 32 is realized so as to be partially cylindrical, the seating table 2 having a matching, at least likewise partially cylindrical opening 33, in which the bearing projection 32 engages in a fitting manner. The seating table 2 delimits a substantially V-shaped recess 34, the bracket 27 and, consequently, the rotary means 4 being pivotable within the recess 34. The V-shaped recess 34 opens into the partially cylindrical opening 33. Here, at each side, the recess 34 constitutes a stop (not designated in greater detail) for the bracket 27. Preferably, the rotary means 4 can be pivoted from +45° to −45°. The recess 34 therefore preferably has an opening angle of 90° or of more than 90°. The pivoting movement of the bracket 27 together with the rest of the rotary means 4 is delimited by the recess 34.

The projections 10 of the seating table 2 are realized so as to be substantially acute-angled, and are delimited by stop strips 35. The stop strips 35 serve to seat the workpiece. The stop strips 35 in this case extend flush with one another, preferably substantially as far as the vertical axis H. The stop strips 35 in this case can extend substantially as far as the preferably partially cylindrical opening 33, or as far as the bearing projection 32, or just beyond the bearing projection 32. In the design represented here, the seating table 2 has a respective slot (not designated in greater detail), in which the stop strips 35 engage by means of an elongate projection, not designated in greater detail. The stop strips 35 are disposed so as to be displaceable along the slot. The stop strips 35 can preferably be detachably fixed in the slot by means of a respective clamping screw (not designated in greater detail).

The crosscut and miter saw 1 stands on a base frame 43. Here, the base frame 43 consists substantially of two feet 44. The solid assembly composed of the seating table 2 and the base plate 5 is supported on the ground by means of the base frame 43, in particular the two feet 44. The base frame 43, in particular the feet 44, is/are disposed so as to be movable, preferably pivotally movable, on the assembly composed of the seating table 2 and the base plate 5, such that irregularities of the ground can be compensated. The pivot position of the two feet 44 can be set relative to the assembly by means of a setting screw 45 (cf. FIG. 13).

The disadvantages described at the outset are avoided in that the inset 30 and/or the receiver 29 is or are realized in such a way that the inset 30—relative to the seating table 2 and/or relative to the rotary means base 28—can be disposed in a height adjustable manner and/or the alignment of the inset 30 can be set in respect of height. At least one adjusting means 36 is preferably provided for this purpose, by means of which the inset 30 can be disposed or is disposed so as to be adjustable in respect of height, preferably steplessly, in particular relative to the seating table 2 (cf. in relation thereto, in particular, FIGS. 8 and 9). This has the advantage that the height of the top side 26 of the bracket 17, or of the bearing projection 32, thus the height of the top side 26 of the inset 30, can be made level with the height of the seating table 2. In particular, the inset 30 is therefore realized so as to be adjustable in respect of height relative to the rotary means base 28. Preferably, a plurality of adjusting means 36 are provided.

The respective adjusting means 36 preferably has an adjusting screw 37. The adjusting means 36, in particular the adjusting screw 37, can connect the rotary means base 28 and the inset 30 to one another. Further, the adjusting means 36 preferably has a spring element 38. The spring element 38 is preferably disposed between the rotary means base 28 and the inset 30. The spring element 38 is compressed by the adjusting means 36 and preferably counters the force of the adjusting screw 37. The adjusting screw 37 preferably draws the inset 30 against the rotary means base 28, or against the base of bottom of the receiver 29. For this purpose, the adjusting screw engages in a threaded opening, not designated in greater detail, provided on the bottom of the receiver. The spring element 38 presses the inset 30 upward, away from the bottom of the receiver 29. Tightening of the adjusting screw 37 or slackening of the adjusting screw 37 thus enables the height of the inset 30 to be set, preferably steplessly, relative to the rotary means base 28 and, consequently, relative to the seating table 2. The adjusting screw 37 in this case extends in the vertical direction. Here, the spring element 38 is realized in the form of a ring, and encircles the adjusting screw 37.

Here, to simplify assembly, the inset 30 is preferably realized in multiple parts, and here preferably has a fastening plate 39 and a workpiece seating structure 40 disposed, in particular, above the fastening plate 39. The adjusting screw 37 in this case preferably acts upon the horizontally disposed fastening plate 39. The workpiece seating structure 40 is then fastened on the fastening plate 39. Here, the workpiece seating structure 40 is fastened to the fastening plate 39 by means of fastening screws 41. Alternatively, the inset 30 can also be realized as a single piece.

Furthermore, it is conceivable for the workpiece seating structure 40 and the fastening plate 39 to be connected to one another by a clip mechanism or a latching mechanism. The workpiece seating structure 40 is preferably produced from a plastic. To enable the adjusting screws 37 to be reached by a tool, the workpiece seating structure 40 is provided with a corresponding number of adjusting screw openings 42. The adjusting screw openings 42 are disposed above the adjusting screws 37. The adjusting screw 37 can be actuated by means of a corresponding tool through the adjusting screw openings 42.

Preferably, a plurality of adjusting means 36 are now provided, in particular from FIGS. 8 to 12. As already mentioned above, the insert 30 here is preferably realized in two parts, and thus has, on the one hand, a fastening plate 39 in the lower region and has a workpiece seating structure 40 in the upper region. In this case, the workpiece seating structure 40 is fastened to the fastening plate 39 by means of fastening screws 41, as shown clearly by FIGS. 8 and 9. Via the adjusting screw openings 42, a user can then manually operate the respective adjusting means 36, in particular the adjusting screws 37. Upon corresponding slackening of the adjusting screws 37 (thus, in the case of a direction of turning to the left), the fastening plate 39 is pressed upward by means of the spring elements 38, such that, by means thereof, the top side 26, in particular the top side of the workpiece seating structure 40 is likewise shifted upward, i.e. its height is adjusted/set. In contrast thereto, if the adjusting screws 37 are tightened (thus, turned to the right), a greater force is exerted upon the spring elements 38, such that the base plate 39 is drawn further downward, such that the top side 26 is adjusted downward in respect of its height.

The spring elements 38 can be produced from differing materials. Conceivable are the very great variety of plastic elements, but also appropriate steel, aluminum or sheet metal material that have appropriate spring properties. This is dependent on the respective application. What is crucial is the possibility, preferably, of manual settability/alignment of the top side 26 of the inset 30, in particular the top side 26 of the workpiece seating structure 40 relative to the seating table 20, preferably a stepless height adjustment.

Through the realization of the features mentioned above, crucial disadvantages are avoided and corresponding advantages are achieved.

### LIST OF REFERENCES

1 crosscut and miter saw
2 seating table
3 top side
4 rotary means
5 base plate
6 miter arm
7 sawing device
8 saw blade
9 sliding guide device
10 projection
11 angle scale
12 guide slot
13 sliding guide
14 guide rod
15 rod clamping piece
16 miter-arm mount
17 miter plate
18 counter-plate
19 joint piece
20 elongate hole
21 lever handle
22 rotary handle
23 shaft
24 toothed wheel
25 toothed disk arc
26 top side
27 bracket
27a rotary disk
28 rotary means base
29 receiver
30 inset
31 saw slot
32 bearing projection
33 opening
34 recess
35 stop strip
36 adjusting means
37 adjusting screw
38 spring element
39 fastening plate
40 workpiece seating structure
41 fastening screws
42 adjusting screw openings
43 base frame
44 foot
45 setting screw
H vertical axis
G miter axis

1-14. (canceled)

15. A crosscut and miter saw, comprising:
a seating table;
a rotary device being rotatable about a vertical axis relative to said seating table;
a miter arm being pivotable;
a sawing device disposed on said the miter arm, said sawing device disposed above said seating table such that said sawing device can be moved up and down, including in a pivoting manner; and
said rotary device having a rotary base with a receiver and an inset disposed in said receiver, said inset delimiting a saw slot, at least partially, at least one of said inset or said receiver is realized in such a way that said inset, relative to said seating table and/or relative to said rotary base, can be disposed in a height adjustable manner and/or an alignment of said inset can be set in respect of height.

16. The crosscut and miter saw according to claim 15, further comprising at least one adjusting device for height adjusting or aligning said insert.

17. The crosscut and miter saw according to claim 16, wherein said adjusting device acts between said inset and said rotary base.

18. The crosscut and miter saw according to claim 16, wherein said adjusting device has an adjusting screw, said adjusting screw operatively connecting said rotary base and said inset to one another.

19. The crosscut and miter saw according to claim 18, wherein said adjusting device has a spring element.

20. The crosscut and miter saw according to claim 19, wherein said spring element is disposed between said rotary base and said inset.

21. The crosscut and miter saw according to claim 19, wherein said spring element is a ring, and encircles said adjusting device.

22. The crosscut and miter saw according to claim 16, wherein said inset has a fastening plate and a workpiece seating structure.

23. The crosscut and miter saw according to claim 22, wherein said fastening plate acts together with said adjusting device, and said workpiece seating structure being disposed, or fastened, on said fastening plate.

24. The crosscut and miter saw according to claim 15, wherein said rotary device has a bracket, and said inset extends along said bracket together with said receiver.

25. The crosscut and miter saw according to claim 15, wherein said inset constitutes a partially cylindrical bearing projection in a region of the vertical axis, and said seating table has an at least partially cylindrical opening formed therein, said partially cylindrical bearing projection engaging in said at least partially cylindrical opening in a form fitting manner.

26. The crosscut and miter saw according to claim 15, wherein said rotary device is covered, at least partially, by said seating table.

27. The crosscut and miter saw according to claim 15, wherein said rotary base has a top side that extends, at least partially, below said seating table.

28. The crosscut and miter saw according to claim 19, wherein said spring element is one of a plurality of spring elements that are produced from a material selected from the group consisting of plastics and sheet metal materials.

29. The crosscut and miter saw according to claim 15, wherein said miter arm is pivotable about the vertical axis.

30. The crosscut and miter saw according to claim 16, wherein said adjusting means is one of a plurality of adjusting means.

31. The crosscut and miter saw according to claim 19, wherein said spring element is a ring and encircles said adjusting screw.

32. The crosscut and miter saw according to claim 15, wherein said rotary device further has a rotary disk.

33. The crosscut and miter saw according to claim 25, wherein said inset is a workpiece seating structure.
